(19) United States
(12) Patent Application Publication
(10) Pub. No.: US 2005/0022851 A1
(43) Pub. Date: Feb. 3, 2005

(54) [WATER CLEANING APPARATUS]

(76) Inventor: Jun-Ming Chen, Tainan (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 10/604,543

(22) Filed: Jul. 30, 2003

(51) Int. Cl. B08B 3/00

(52) U.S. Cl. 134/149; 134/153; 134/200; 134/902

(57) ABSTRACT

A wafer cleaning apparatus is provided. The wafer cleaning apparatus comprises a trough, a wafer holder, a rolling device, and a fluid injecting device. The wafer holder is disposed in the trough for holding a plurality of wafers. The rolling device is disposed in the rough and contacts with the wafers held on the wafer holder for rotating the wafers. The wafer injecting device is disposed in the trough for supplying cleaning liquid for cleaning the wafers.

### BACKGROUND OF INVENTION

1. Field of the Invention

The present invention relates to a wafer cleaning apparatus. More particularly, the present invention relates to a wafer cleaning apparatus with enhanced uniformity and efficiency of wafer cleaning.

2. Description of the Related Art

In a process of making integrated circuit devices, the most frequently used step is wafer cleaning. The purpose of wafer cleaning is to remove organic compounds, metal impurities or particles adhered on the surface of the wafers. These pollutants can adversely affect the subsequent process steps. Metal impurities can cause electrical leakage on p-n interface, shorten lifetime of minority carriers, and lower collapse voltage of gate oxide. Particles adhered on the wafers can affect the authenticity of pattern transference during a photolithography process and even cause circuit shorting. Thus, through a wafer cleaning process, organic compounds, metal impurities and particles adhered on the surfaces of the wafers must be effectively removed, there must be no pre-existing oxide layer on the surfaces of the wafers, and the surface coarseness must be extremely low.

FIG. 1 is a schematic sectional view of a conventional wafer cleaning apparatus. Referring to FIG. 1, the wafer cleaning apparatus 100 is mainly consisted of a trough 102, a wafer holder 106, and a fluid injecting device 108. The wafer holder 106 is disposed in the trough 102 for holding a plurality of wafers 104 therein. The fluid injecting device 108 is disposed on the bottom of the trough 102 and is perpendicular to the surface of the wafers 104 to supply cleaning liquid for cleaning the wafers 104.

However, in the foregoing wafer cleaning apparatus 100, the wafers 104 and the fluid injecting device 108 are fixed within the trough 102, and thus the direction of the fluid injecting 110 is also fixed and unalterable. Consequently, in a wafer cleaning process using the foregoing wafer cleaning apparatus 100, the wafers 104 cannot be cleaned uniformly. Moreover, as shown by the wafer 202 in FIG. 2, defects and eroded regions 204 are liable to be generated on both sides of the wafer 204 during the wafer cleaning process.

### SUMMARY OF INVENTION

Accordingly, an object of the present invention is to provide a wafer cleaning apparatus to uniformly clean wafers so as to avoid defects and erodes from occurring on the wafer surface during a wafer cleaning process.

According to another object of the present invention is to provide a wafer cleaning apparatus for enhancing the cleaning efficiency.

In accordance to the above objects and other advantages of the present invention, as broadly embodied and described herein, the present invention provides a wafer cleaning apparatus comprising a trough, a wafer holder, a rolling device, and a fluid injecting device. The wafer holder is disposed in the trough for holding a plurality of wafers. The rolling device is placed in the trough, wherein the rolling device is in contact with the wafers held in the wafer holder for rotating the wafers on the wafer holder. The fluid injecting device is disposed in the trough for supplying cleaning liquid for cleaning the wafers.

The present invention further provides a wafer cleaning apparatus comprising a trough, a wafer holder, a rolling device, and an adjustable fluid injecting device. The wafer holder is disposed in the trough for holding a plurality of wafers. The rolling device is disposed in the trough, wherein the rolling device is in contact with the wafers held in the wafer holder for rotating the wafers on the holder. The adjustable fluid injecting device is disposed in the trough to supply cleaning liquid for cleaning the wafers, wherein the direction of injecting water from the adjustable fluid injecting device to the wafers is adjustable.

According to one aspect of the present invention, since the rolling device disposed in the trough rotates the wafers in the wafer holder during cleaning process, and therefore the wafers can be cleaned uniformly. Thus the problems of defects and erosion as observed in the prior art can be effectively avoided.

According to another aspect of the present invention, since the adjustable fluid injecting device disposed in the trough, is capable of adjusting the direction of the injecting fluid, relative to the rotating motion of the rolling device, and therefore the efficiency of the wafer cleaning process can be effectively enhanced. Further, the flow rate as well as velocity of cleaning liquid can also be adjusted to further enhance the efficiency and cleaning uniformity of the wafer cleaning process.

It is to be understood that both the foregoing general description and the following detailed description are exemplary, and are intended to provide further explanation of the invention as claimed.

### BRIEF DESCRIPTION OF DRAWINGS

The accompanying drawings are included to provide a further understanding of the invention, and are incorporated in and constitute a part of this specification. The drawings illustrate embodiments of the invention and, together with the description, serve to explain the principles of the invention. The drawings are as follows.

FIG. 1 is a schematic sectional view of a conventional wafer cleaning apparatus.

FIG. 2 is a schematic view showing erosion on the both sides of wafers after performing a cleaning process using the conventional wafer cleaning apparatus.

FIG. 3 is a schematic sectional view of a wafer cleaning apparatus according to one preferred embodiment of the present invention.

FIG. 4 is a schematic cross sectional view of the wafer cleaning apparatus taken along a perpendicular direction with respect to the view shown in FIG. 3.

FIG. 5 is a schematic sectional view showing the wafer cleaning apparatus according to another preferred embodiment of the present invention.

FIG. 6 is a schematic sectional view showing the wafer cleaning apparatus according to another preferred embodiment of the present invention.

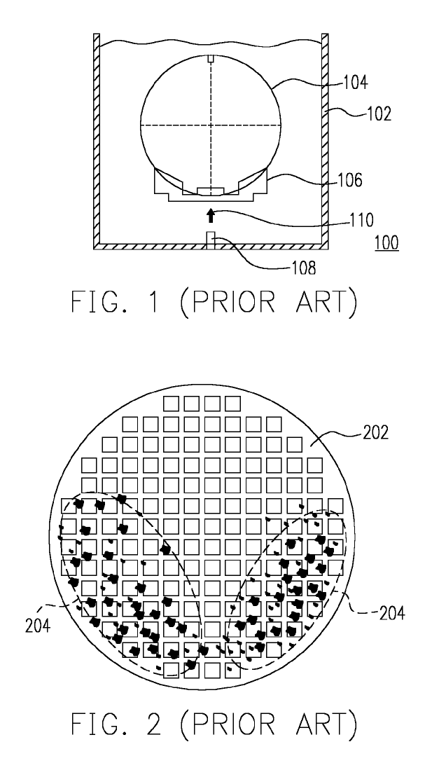

### DETAILED DESCRIPTION

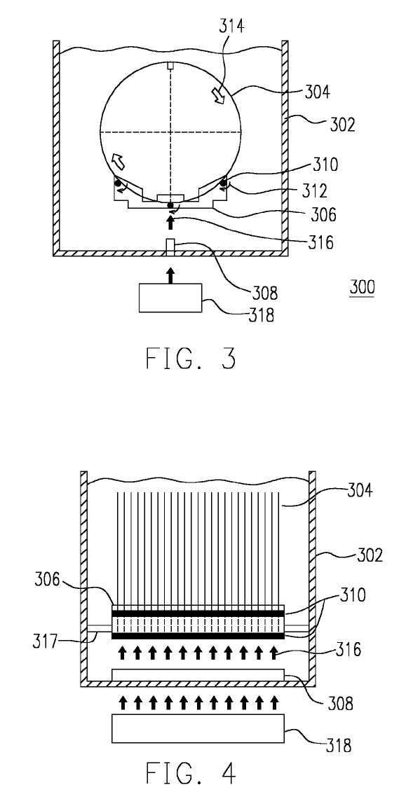

Referring to FIGS. 3 and 4, the wafer cleaning apparatus 300 of the preferred embodiment of the present invention comprises a trough 302, a wafer holder 306, a rolling device 310, and a fluid injecting device 308.

The wafer holder 306 is disposed in the trough 302 for holding a plurality of wafers 304, wherein the wafer holder 306 can be, for example, fastened on the body of the trough 302 via a framework 317.

Referring to FIGS. 3 and 4, the rolling device 310 is placed in the trough 302, for rotating the wafers 304 on the wafer holder 306, wherein the rolling device is in contact with the wafers 304 held in the wafer holder 306. The rolling device 310 includes, for example, at least one roller. In the preferred embodiment of the present invention, the rolling device 310 includes three rollers, wherein the rollers are disposed on the two sides of the wafer holder 306 and are positioned perpendicular to the surface of the wafers 304, and wherein the rollers contact the edges of the wafers 304.

Further referring to FIGS. 3 and 4, the fluid injecting device 308 is disposed on the bottom of the trough 302 and positioned perpendicular to the surface of the wafers 304, to supply cleaning liquid for cleaning the wafers 304. Wherein, the fluid injecting device 308 has a capability to control the flow rate as well as velocity of the cleaning liquid. The cleaning liquid is, for example, water or a chemical fluid. A cleaning liquid supplier 318 can be connected to the fluid injecting device 308 for supplying cleaning liquid to the fluid injecting device 308.

In addition, the foregoing rolling device 310 can include a motor (not shown), and the motor contacts with the rollers for driving the rollers to rotate the wafers 304.

Referring to FIG. 3, in a process of wafer cleaning by using the foregoing wafer cleaning apparatus 300, the rolling device 310 is driven by the motor to rotate in the direction 312 as shown in FIG. 3. The rolling device 310 contacts with the edges of the wafers 304 and rotates the wafers 304 in the direction 314 as shown in FIG. 3. Consequently, the wafers 304 are continuously rotated as the fluid injecting device 308 injects cleaning liquid to clean the wafers 304 during the cleaning process. Therefore, the problems of defects and erosion on both sides of wafers placed on the wafer holder as observed in the prior art can be effectively avoided.

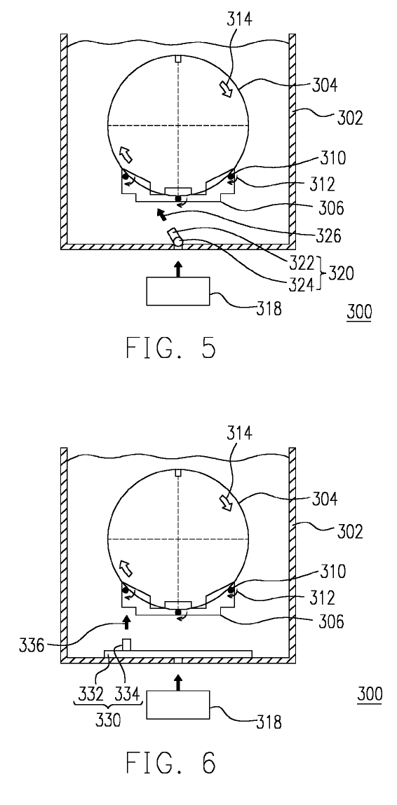

In addition to the preferred embodiment as shown in FIGS. 3 and 4, the present invention has other embodiments. FIG. 5 is a schematic sectional view showing another preferred embodiment of the wafer cleaning apparatus of the present invention. For simplicity and clarity, descriptions are omitted for the elements in FIG. 5 marked with the identical serial numbers as those in FIG. 3. Distinguishable from the embodiment as shown in FIGS. 3 and 4, the preferred embodiment as shown in FIG. 5 utilizes an adjustable fluid injecting device 320 including a turning device 324 and a fluid injecting inlet 322. The turning device 324 is disposed on the bottom of the trough 302 and is connected to the cleaning liquid supplier 318 for receiving cleaning liquid from the cleaning supplier 318. The fluid injecting inlet 322 is disposed on the turning device 324 for altering the angle, i.e., the direction 326, of fluid injection via the turning device 324.

In a wafer cleaning process using the wafer cleaning apparatus 300 as shown in FIG. 5, the wafers 304 are continuously rotated by the rolling device 310, and the direction 326 of the fluid injection from the adjustable fluid injecting device 320 can be adjusted relative to the rotation motion of the rolling device 310 so that the efficiency and the uniformity of the cleaning process can be enhanced. Further, the flow rate as well as velocity of cleaning liquid can also be adjusted to further enhance the efficiency and the uniformity of the cleaning process.

FIG. 6 is a schematic sectional view showing the wafer cleaning apparatus according to another preferred embodiment of the present invention. Similarly, for simplicity and clarity, descriptions are omitted for the elements in FIG. 6 marked with the identical serial numbers as those in FIGS. 3-5. Distinguishable from the foregoing two embodiments, the preferred embodiment as shown in FIG. 6 utilizes an adjustable fluid injecting device 330 including a transmitting device 324 and a fluid injecting inlet 334. The transmitting device 332 is disposed on the bottom of the trough 302 and is connected to the cleaning liquid supplier 318 for receiving cleaning liquid from the cleaning supplier 318. The fluid injecting inlet 334 is disposed on the transmitting device 332 for altering the position of fluid injection in the trough 302 via the transmitting device 332.

In a wafer cleaning process using the wafer cleaning apparatus 300 as shown in FIG. 6, the wafers 304 are continuously rotated by the rolling device 310, and the direction 326 of the fluid injection from the adjustable fluid injecting device 330 can be adjusted relative to the motion of the rolling device 310. Further, the flow rate as well as velocity of cleaning liquid to the trough can be adjusted to further enhance the efficiency and the uniformity of the cleaning process.

In view of the foregoing, the wafer cleaning apparatus of the present invention has at least the following advantages.

First, in the wafer cleaning apparatus of the present invention, since the rolling device is disposed in the trough for rotating the wafers during the wafer cleaning process, and therefore the wafers can be cleaned uniformly. Thus the defects and erosions as observed in the prior art can be effectively avoided.

Secondly, in the wafer cleaning apparatus of the present invention, since the adjustable fluid injecting device is disposed in the trough has a capability to adjust the direction of the fluid injection relative to the rotation motion of the rolling device, and therefore the efficiency and uniformity of the wafer cleaning process can be effectively enhanced. Further, the flow rate as well as velocity of cleaning liquid can also be adjusted to further enhance the efficiency and uniformity of the cleaning process.

It will be apparent to those skilled in the art that various modifications and variations can be made to the structure of the present invention without departing from the scope or spirit of the invention. In view of the foregoing, it is intended that the present invention covers modifications and variations of this invention provided they fall within the scope of the following claims and their equivalents.

1. A wafer cleaning apparatus comprising:
a trough;
a wafer holder disposed in the trough for holding a plurality of wafers;
a rolling device disposed in the trough, wherein the rolling device is in contact with the wafers on the wafer holder for rotating the wafers on the wafer holder; and
a fluid injecting device disposed in the trough for supplying cleaning liquid for cleaning the wafers.

2. The wafer cleaning apparatus of claim 1, wherein the rolling device comprises at least one roller, wherein the roller is disposed on at least one side of the wafer holder positioned perpendicular to the surface of the wafers and contacts with the edges of all of the wafers.

3. The wafer cleaning apparatus of claim 2, wherein the rolling device further comprises a motor for driving the roller to rotate.

4. The wafer cleaning apparatus of claim 1, further comprising a chemical fluid supplier, wherein the chemical fluid supplier is connected to the fluid injecting device.

5. A wafer cleaning apparatus comprising:
a trough;
a wafer holder disposed in the trough for holding a plurality of wafers;
a rolling device disposed in the trough, wherein the rolling device contacts with the wafers for rotating the wafers on the wafer holder; and
an adjustable fluid injecting device disposed in the trough for supplying cleaning liquid for cleaning the wafers, wherein the adjustable fluid injecting device is capable of adjusting the direction of the cleaning liquid injection from the fluid injecting device.

6. The wafer cleaning apparatus of claim 5, wherein the rolling device comprises at least one roller, and the roller is disposed on at least one side of the wafer holder positioned perpendicular to the surface of the wafers and contacts with the edges of the wafers.

7. The wafer cleaning apparatus of claim 6, wherein the rolling device further comprises a motor for driving the roller to rotate.

8. The wafer cleaning device of claim 5, wherein the adjustable fluid injecting device further comprises:
a turning device; and
a fluid injecting inlet disposed on the turning device, wherein the fluid injecting inlet can alter the angle of fluid injection via the turning device.

9. The wafer cleaning device of claim 5, wherein the adjustable fluid injecting device further comprises:
a transmitting device; and
a fluid injecting inlet disposed on the transmitting device, wherein the fluid injecting inlet can alter the position of fluid injection via the transmitting device.

10. The wafer cleaning device of claim 5 further comprising a chemical fluid supplier, wherein the chemical fluid supplier is connected to the adjustable fluid injecting device.
